(19) United States
(12) Patent Application Publication
(10) Pub. No.: US 2005/0177780 A1
(43) Pub. Date: Aug. 11, 2005

(54) Powered interface card and method of providing backup power supply

(76) Inventor: An-Sheng Chang, Taichung Hsien (TW)

Correspondence Address: RABIN & BERDO, P.C., Suite 500, 1101 14 Street N.W., Washington, DC, 20005, US

(21) Appl. No.: 10/762,453

(22) Filed: Jan. 23, 2004

(51) Int. Cl. G06F 11/00

(52) U.S. Cl. 714/47

(57) ABSTRACT

An interface card with a power supply includes a power module and a power charging module. The power module provides power to the host when the power supply of the host connected to the interface card is malfunctioning. When the capacity of the power module is insufficient, it is recharged by the host power supply via the power charging module.

### BACKGROUND OF THE INVENTION

1. Field of Invention

The invention relates to an interface card and, in particular, to an interface card with a power supply.

2. Related Art

Power interrupt or abnormal voltage supply often result in data or system damages due to improper shut down of the computer system. To prevent such incidents from happening, a simple interface card is required. It should contain a battery and be directly installed in the computer system. Once the interface card is connected to a host, it can detect the power supply situation and makes appropriate adjustments accordingly. For example, if the power supply to the computer system is normal, the power is then provided to the computer and to charge the battery in the interface card. When the host power supply is disconnected, the interface card can immediately convert the DC power stored in the battery into a current that is required by the computer system. Thus, the computer has enough time to record unsaved data and to shut down the system.

### SUMMARY OF THE INVENTION

In view of the foregoing, an objective of the invention is to provide an interface card with a power supply and a method for providing a backup power supply. When the interface card is connected to the computer system host, it can provide the necessary power when the host power supply is not functioning correctly. After recording unsaved data, the computer system automatically shuts down so that the system can return to its original state the next time it is turned on.

The disclosed method of providing a backup power supply is for computer systems that contain an interface with a power supply. The method includes the steps of: detecting the abnormality of the interface card and insufficient power supply, sending a warning message to the computer system and recharging the interface card from the power supply module of the computer system, using the power of the interface card to run the computer system when power supply abnormality is detected, controlling the computer system to record data and the computer system state, and shutting down the computer system after the data are saved.

The disclosed interface card contains a power module and a power charging module. The power module provides power to the host when the power supply of the host connected with the interface card functions abnormally. When the power module is low in capacity, the power supply of the host replenishes the power module via the power charging module.

### BRIEF DESCRIPTION OF THE DRAWINGS

The invention will become more fully understood from the detailed description given hereinbelow illustration only, and thus are not limitative of the present invention, and wherein:

FIG. 1 is a preferred embodiment of the invention, showing a computer system with backup power and its composition; and

FIG. 2 is a flowchart of the disclosed method for providing backup power according to FIG. 1.

### DETAILED DESCRIPTION OF THE INVENTION

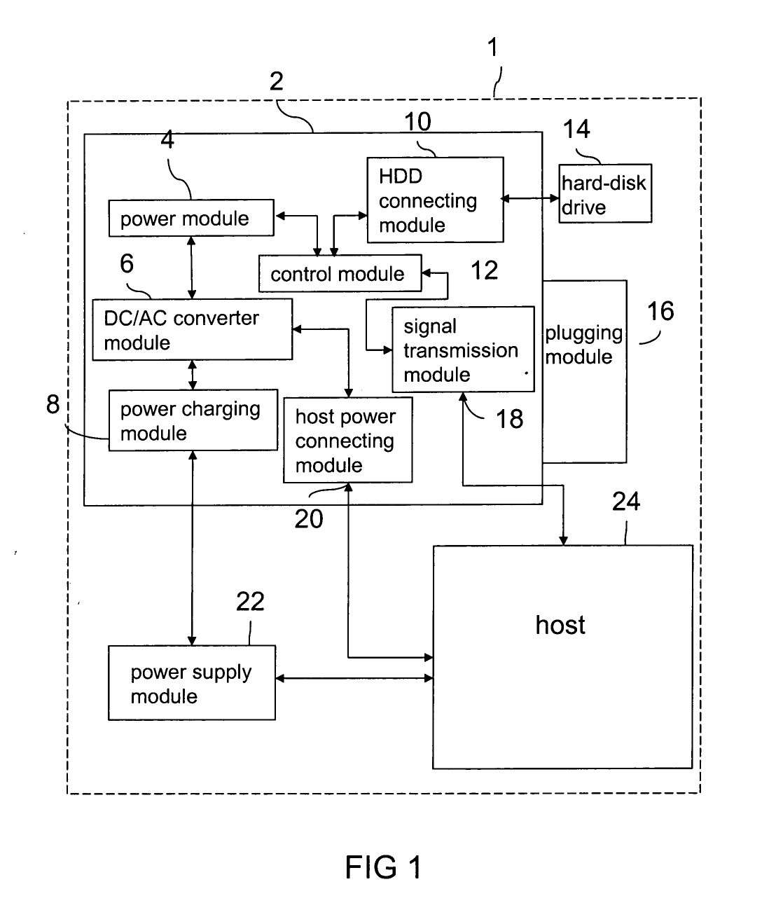

FIG. 1 shows a preferred embodiment of the invention. The computer system 1 contains an interface card 2 with a power supply, a host 24 for plugging the interface card 2, a hard-disk drive (HDD) 14, and a power supply module 22. The interface card 2 contains a power charging module 8, a DC/AC converter module 6, a control module 12, a power module 4, an HDD connecting module 10, a host power connecting module 20, a signal transmission module 18, and a plugging module 16. Please refer to FIG. 1. The interface card 2 is connected to the power supply module 22 of the host 24 via the power charging module 8. It uses the signal transmission module 18 to communicate control signals with the host 24. Through the host power connecting module, the interface card 2 provides the host 24 backup power. It uses the HDD connecting module 10 to connect with the HDD 14. Its control module 12 controls the above-mentioned modules and monitors the states of the power module 4 of the interface card 2 and the power supply module 22 of the host 24. In this system, the power supply module 22 supplies an external power to the host 24. When the control module 12 detects that the capacity of the power module 4 is insufficient, it directs DC power to replenish the power module 4 via the power supply connecting module 8. If it detects the capacity of the power supply module 22 is low, the power module 4 of the interface card 2 converts its power using the DC/AC converter module 6 and sends the power to the power supply module 22 for the host 24 to use. The signal transmission module 18 is connected to the host 24 for transmitting control signals. The host can obtain information about the states of the power module 4 of the interface card 2 and the power supply module 22 of the host 24 from the signal transmission module 18. The control module 12 can also send out warning messages such as insufficient power in the interface card, abnormal battery state, abnormal host power supply, and so on via the signal transmission module 18. The plugging module can use the ISA bus or PCI bus structure.

With reference to the preferred embodiment in FIG. 1, we describe the method of the invention as follows. When the computer system 1 is turned on, the backup power management program in the host 24 automatically checks the state of the interface card 2 and the power module 4 via the control module 12, determining whether the interface card and the power module 4 can operate correctly. If the interface card 2 can correctly function, it further checks whether the power module 4 has a sufficient voltage to provide power of 3.3V, 12V, and 5V. Once the voltage of the power module 4 is determined to be sufficient, the control module 12 starts to continuously monitor whether the external power connecting to the power supply module 22 of the host 24 is normal. If the control module 12 detects that the interface card 2 cannot function, it sends via the signal transmission module 18 a warning message to the host 24 to notify the user, without affecting the operation of the host 24. If the voltage of the power module 4 is low, a corresponding message will be sent via the control module 12 to the host 24. Once the backup power management program receives the message, it controls the power supply module 22 of the host 24 to charge the power module 4 of the interface card 2. Suppose everything is normal, the backup power management program starts to continuously monitor the state of the power supply module 22 of the host 24. If anything goes wrong with the power supply to the host, the backup power management program notifies the control module 12 of the interface card 2 so that the control module 12 can control the power module 4 to start supplying power to the host 24. It also notifies the host 24 to save data and record the current state of the system 1. Once the data are saved, the backup power management program controls the host 24 to shut down in the normal way. When the system is turned on again after the power supply is back to normal, the backup power management program returns the system 1 to the original state before shut down.

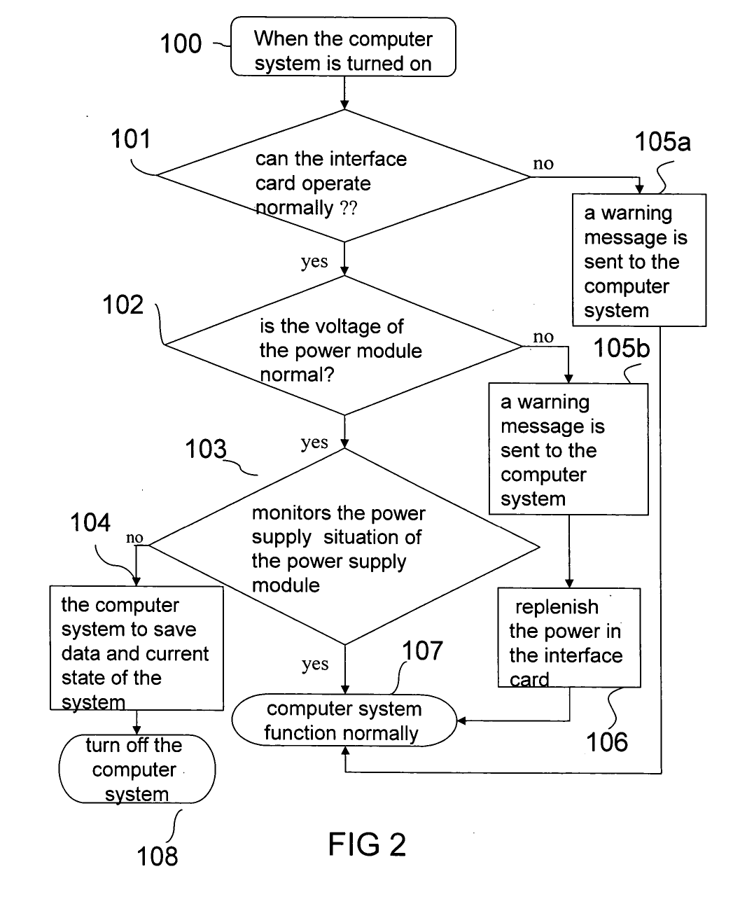

FIG. 2 is a flowchart of providing backup power according to the first embodiment in FIG. 1. When the computer system 1 is turned on (step 100), the backup power management program automatically checks whether the interface card 2 can operate normally (step 101). Such checks include whether the card is installed correctly. If the interface card 2 is found to function incorrectly, a warning message is sent to the computer system 1 to notify the user (step 105a). However, the computer system 1 still function normally (step 107). If the state of the interface card 2 is normal, it further checks whether the voltage of the power module 4 is normal (step 102), such as whether it can provide power of 5V, 3.3V, or 12V. If the computer system 1 determines that the power module 4 cannot provide such voltages, a warning message is sent to the computer system 1 to notify the user (step 105b) and to notify the host power supply module 22 to replenish the power in the interface card 2 (step 106). If both the state of the interface card 2 and the voltage of its power module are normal, the backup power management program continuously monitors the power supply situation of the power supply module 22 (step 103). Once any abnormal power supply is detected, e.g. disconnected power supply, the backup power management program sends out a warning message to notify the user and automatically controls the computer system to save data and current state of the system 1 (step 104). Once the data are all saved, a shut down message is sent out for the computer system 1 to turn off (step 108).

Certain variations would be apparent to those skilled in the art, which variations are considered within the spirit and scope of the claimed invention.

1. An interface card with power supply and connected to a host, the interface card comprising:
a power module; and
a power charging module;
wherein the power module provides electrical power to the host when the host power supply functions incorrectly and the power module is recharged via the power charging module by a power supply module of the host when the power module is low in capacity.

2. The interface card of claim 1, wherein the connection between the interface card and the host uses an ISA bus.

3. The interface card of claim 1, wherein the connection between the interface card and the host uses a PCI bus.

4. The interface card of claim 1 further comprising a control module for detecting the power module and an external power source state connected to the power charging module and for sending a warning message to the host when the power module and the external power source state are found to be abnormal.

5. The interface card of claim 1 further comprising a host power connecting module to transfer power to the host.

6. A computer system with backup power, comprising:
a host; and
an interface card with power supply;
wherein the interface card connects to the host via a bus and provides power to the host when the power supply of the host functions incorrectly.

7. The computer system of claim 6, wherein the interface card further includes a power module for supplying power to the host when the power supply of the host functions incorrectly.

8. The computer system of claim 6, wherein the interface card further includes a power charging module for receive power from a power supply module of the host when the power module is low in capacity.

9. The computer system of claim 6, wherein the interface card further includes a control module for detecting the power states of the interface card and the host and for sending a warning message to the host when the power states are found to be abnormal.

10. The computer system of claim 6, wherein the interface card is connected to the host via an ISA bus.

11. The computer system of claim 6, wherein the interface card is connected to the host via a PCI bus.

12. A method for providing backup power used in a computer system that contains an interface card with power supply, a host for the interface card to plug in, and a power supply module for supplying power to the host and the interface card, the method comprising the steps of:
(a) supplying power from the power supply module to the interface card when the power of the interface card is detected to be insufficient;
(b) supplying power from the interface card to the host when the host power supply is detected to be abnormal and controlling the computer system to automatically save data and its current state; and
(c) shutting down the computer system once the data are all saved.

13. The method of claim 12, wherein step (c) is followed by the step of returning the computer system to its saved state when it is restarted.

14. The method of claim 12, wherein step (a) is preceded by the step of checking whether the interface card functions normally.

15. The method of claim 12, wherein step (a) is preceded by the step of sending a warning message to the computer system when the interface card is detected to function abnormally.

16. The method of claim 12, wherein step (a) includes the step of sending a warning message to the computer system.
